(19) United States
(12) Patent Application Publication
(10) Pub. No.: US 2015/0265494 A1
(43) Pub. Date: Sep. 24, 2015

(54) BACK RELAX

(71) Applicant: Rick Keppler, El Segundo, CA (US)

(72) Inventor: Rick Keppler, El Segundo, CA (US)

(21) Appl. No.: 14/220,066

(22) Filed: Mar. 19, 2014

(51) Int. Cl. A61H 15/00

(52) U.S. Cl. CPC A61H 15/00; A61H 2201/0192; A61H 2201/1669; A61H 2205/081

(57) ABSTRACT

A back relax apparatus in accordance with the present invention is disclosed. The back relax apparatus comprises a bendable generally cylindrically shaped plastic container. The bendable flexible plastic container may be bent arbitrarily into several positions to contact different parts of a person's back for performing a back massage as is well known in the physical therapy arts.

### FIELD OF THE INVENTION

The present invention relates to massagers in general and in particular to a device for massaging and relaxing a back body portion of a user.

### BACKGROUND OF THE INVENTION

It is well known that many people will suffer from stiffness and back pain during their lifetime. Typically, oral or topical medications are used by people to relieve this stiffness and back pain. However, using oral or topical medications are temporary and only mask or otherwise disguise the pain. In these cases, the pain often returns after the medication wears off. In addition, these medications can have other side effects such as drowsiness which are inadvisable for people who are operating heavy equipment, are in a medical profession such as a doctor or nurse or are driving their vehicles for example.

The use of alternative treatments for back stiffness and/or pain such as acupuncture or massage is used by some people wherein such alternative treatments need to be administered by a professional. Such professionals are expensive and require time consuming appointments to receive the benefits of such treatment. These appointments are often not practical for people with busy schedules.

Previous devices have attempted to provide back massagers for use in a vehicle. However such devices typically engage the entire person's back, such as for example, in the form of a beaded device which may cover an entire vehicle seat and which may overall be uncomfortable for the driver. Additionally, these types of devices are not able to provide a massage at a specific point on the back of the person. These devices are also not adapted to be utilized in other settings such as office or household chairs or any other seating location by the person desiring to relieve their back pain or to relax specific back portions of their body.

### SUMMARY

A back relax apparatus in accordance with the present invention is disclosed. The back relax apparatus comprises a bendable generally cylindrically shaped plastic container. The bendable flexible plastic container may be bent arbitrarily to contact any part of a portion of a person's back for performing a back massage as is well known in the physical therapy arts. More specifically, three different types of massages may be performed by different bends of the container, namely, an “edgy” massage on one side and a round flat massage on the other wherein selectively bending the container at its middle portion creates two roundish/edgy points on each side used to provide one of the massages and selectively bending the container to create a single circular flat surface and a roundish edge at opposite ends of the plastic container create the second type of massage. Lastly, selectively bending the container to create a pair of single circular flat surface at opposite ends of the plastic container create the third type of massage

### DESCRIPTION OF THE DRAWINGS

FIG. 1 is a side view of one embodiment of the back relax apparatus according to the present invention;

FIG. 2 top view of the back relax apparatus shown in FIG. 1;

FIG. 3 is a side view of another embodiment of the back relax apparatus according to the present invention;.

FIG. 4 top view of the back relax apparatus shown in FIG. 3, and

FIG. 5 is a side view of still yet another embodiment of the back relax apparatus according to the present invention.

### DESCRIPTION OF EMBODIMENTS

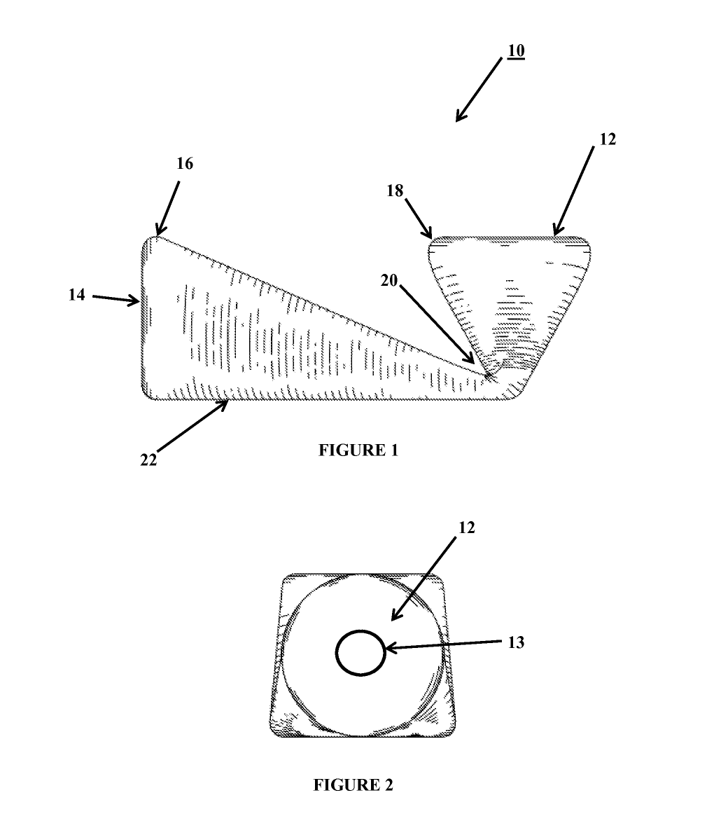

Referring now to FIG. 1, a back relax apparatus in accordance with the present invention comprises a generally bendable cylindrically shaped plastic container 10. The flexible plastic container 10 may be bent arbitrarily to contact any part of a portion of a person's back for performing a back massage as is well known in the physical therapy arts. More specifically, three different types of massages may be performed by different bends of the container as shown in FIGS. 1 through 5 as will be more fully described below.

Turning now to FIG. 1, the flexible plastic container 10 comprises an elongated cylinder having first and second circular planar end caps 12 and 14, respectively. When the flexible plastic container is bent these end caps will either present one or both of their cylindrical flat or planar portions 12 and/or 14 of the plastic container or be bent in such a fashion as to present their edges 16 and/or 18 for contact onto the persons back for different types of massages as will be more fully described below.

Turning once again to FIGS. 1 and 2, a first massage configuration is illustrated, wherein the flexible plastic container 10 has been selectively bent 20 at a location which produces a cylindrical edge 16 on one side of the flexible plastic container 10 and produces the cylinder planar cap 12 at the opposite or distal end. This bent configuration produces for the person the experience of an “edgy” massage on one side while equally feeling a round flat massage on the other side when the plastic container is placed with its elongated backside 22 against a chair or vehicle seat. Additionally, an air release valve 13 as shown in FIGS. 2 and 4 located at either end cap 12 or 14 is open and closed and is used to evacuate the air inside the container during bending in order to retain the container 10 into the desired massage configuration.

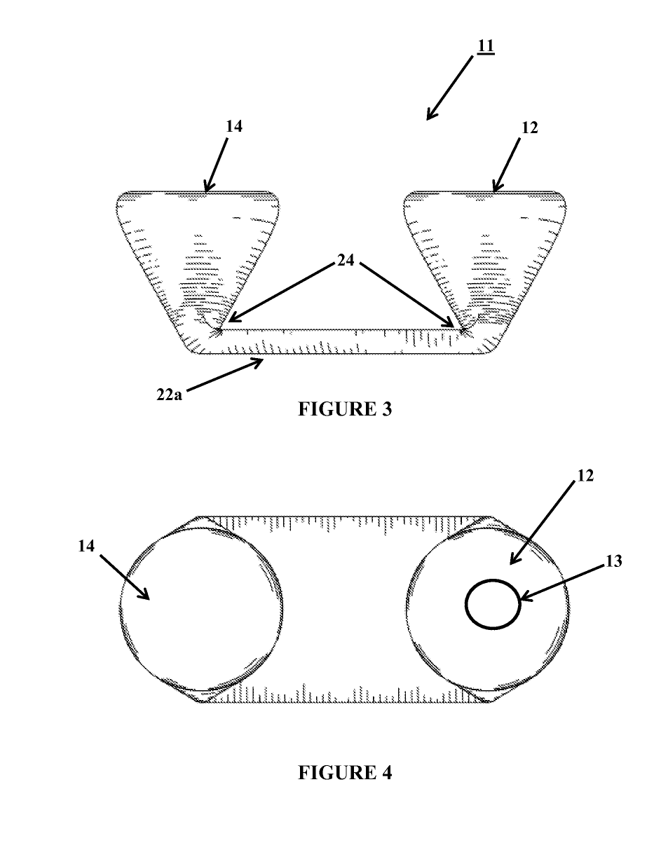

Referring now to FIGS. 3 and 4, a second massage configuration is illustrated, wherein the flexible plastic container 11 has been selectively bent 24 at two locations which produces a cylinder planar cap 14 on one side of the flexible plastic container 11 and produces the cylinder planar cap 12 at the opposite or distal end. This dual bent configuration produces for the person the experience of a round flat massage on both sides wherein the person equally feels a round flat massage on both sides of their back when the plastic container is placed with its elongated backside 22 against a chair or vehicle seat. Once again, an air release valve 32 is used to evacuate the air inside the container in order to retain the container 11 into the massage configuration.

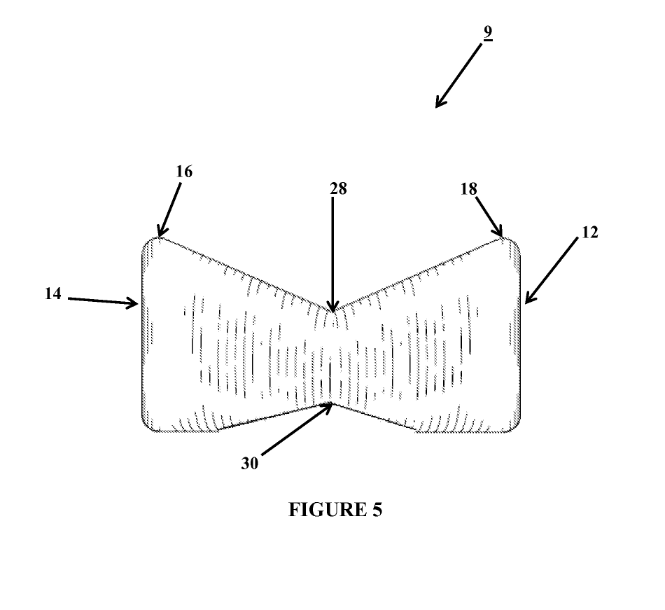

Turning once again to FIG. 5, a third massage configuration is illustrated, wherein the flexible plastic container 9 has been selectively bent 28 at its middle which produces a cylindrical edge 16 on one side of the flexible plastic container 11 which in turn produces a cylindrical edge 18 at the opposite or distal end. This single bent configuration produces for the person the experience of an “edgy” massage on both sides wherein the person equally feels an edgy or sharp pointed massage on both sides of their back when the plastic container is placed with its bent backside 30 against a chair or vehicle seat. Although not shown, it should be understood, an air release valve 32 is opened to evacuate the air inside the container and then closed in order to retain the container 11 into the massage configuration.

In use, a person bends the container into the configuration which produces the edge configuration they desire as described above by evacuating the containers interior air and closing off the release valve. Next, the person places the bent container in a chair or vehicle seat located such that the massage side or chosen edge configuration of the container touches their back while the opposite side of the container rests against the back of their chair or vehicle seat. The person may now press up against the container or roll up and down against the container to achieve a massage experience.

It will be appreciated that modifications may be made to the shape and construction of the back relax apparatus which may, for example, be made of many different materials, and to methods of using the back relax apparatus without departing from the spirit and scope of the present invention.

What is claimed is:

1. A back relax apparatus comprising:
an elongated flexible cylinder having first and second circular flat planar end caps on a first and distal end;
said first and second circular flat planar end caps further defining associated first and second rounded edges; wherein
said elongated flexible cylinder is selectively bent for use as a massage device.

2. The back relax apparatus as claimed in claim 1, wherein said elongated flexible cylinder is bent to produce a rounded edge at one end and an opposite circular planar end.

3. The back relax apparatus as claimed in claim 1, wherein said elongated flexible cylinder is bent twice to produce a pair of opposite circular planar ends.

4. The back relax apparatus as claimed in claim 1, wherein said elongated flexible cylinder is bent in the middle to produce a pair of opposite rounded edges.

5. The back relax apparatus as claimed in claim 1, wherein said elongated flexible cylinder is a plastic container.

6. The back relax apparatus as claimed in claim 1, wherein either of said circular flat planar end caps defines an air release valve for holding the cylinder's shape after being bent.

7. A method for relaxing a person's back, comprising the steps of:
bending a container having flat circular cap ends defining cap edges into a select configuration;
resting said container against a seat;
placing the person's back up against the container wherein the person performs a desired massage.

8. The method according to claim 7, further comprising the step of bending the container so as to define a cap edge opposite a flat circular cap end.

9. The method according to claim 7, further comprising the step of bending the container so as to define a pair of cap edges opposite each end of said container.

10. The method according to claim 7, further comprising the step of bending the container so as to define a pair of flat circular caps opposite each end of said container.

11. The method according to claim 7, further comprising the step retaining said containers shape using an air release valve.

12. The method according to claim 7, further comprising the step of using a plastic container.
